(19) United States
(12) Patent Application Publication
(10) Pub. No.: US 2005/0179337 A1
(43) Pub. Date: Aug. 18, 2005

(54) Axial gap electric rotary machine

(76) Inventors: Masahiro Hasebe, Aichi (JP); Masami Ishikawa, Aichi (JP); Akira Mizuno, Aichi (JP); Yoji Takeda, Osaka (JP); Masayuki Sanada, Osaka (JP)

Correspondence Address: LORUSSO, LOUD & KELLY, 3137 Mount Vernon Avenue, Alexandria, VA, 22305, US

(21) Appl. No.: 10/983,894

(22) Filed: Nov. 9, 2004

(30) Foreign Application Priority Data
Nov. 10, 2003 (JP) 2003-380296

(51) Int. Cl. H02K 21/12; H02K 3/00; H02K 1/22

(52) U.S. Cl. 310/268; 310/216; 310/156.08

(57) ABSTRACT

An axial gap electric rotary machine includes a rotor and a stator which face each other with an axial gap therebetween. The rotor includes permanent magnets which are arranged with their magnetic poles spaced around the circumference of the rotor, with the magnetic poles of adjacent permanent magnets being opposite each other. The permanent magnets and rotor cores are alternately arranged around the circumference of the rotor. Consequently, north poles and south poles are alternately formed at a surface of the rotor facing the stator, and reluctance of a magnetic path which passes through a permanent magnet is larger than reluctance of a magnetic path which does not pass through the permanent magnet, whereby the functions of a reluctance type rotary machine and a permanent magnet synchronous machine are combined in a compact structure.

### CROSS-REFERENCE TO RELATED APPLICATIONS

This application claims, under 35 USC 119, priority of Japanese Application No. 2003-380296 filed Nov. 10, 2003. Related subject matter is disclosed and claimed by the present inventors in Application Serial No. 10/______ (Attorney Docket No. EQU-C489) for “AXIAL GAP ELECTRIC ROTARY MACHINE”, filed on even date herewith.

### INCORPORATION BY REFERENCE

The disclosure of Japanese Patent Application No. 2003-380296 filed on Nov. 10, 2003 including the specification, drawings and abstract is incorporated herein by reference in its entirety.

### BACKGROUND OF THE INVENTION

1. Field of the Invention

The present invention relates to an electric rotary machine such as a motor or generator. Particularly, the present invention relates to an axial gap electric rotary machine in which a rotor and a stator face each other and are axially spaced across the axial gap.

2. Description of the Related Art

One known axial gap motor has a disc-type rotor and a stator arranged at an end face of the rotor, facing and axially spaced from the rotor, with a gap therebetween. The rotational driving force of the motor is a magnetic force that acts between the surface of the rotor and the surface of the stator that face each other across the axial gap. The axial gap motor is advantageous in that it has a smaller axial dimension compared to a conventional radial-type motor which has a cylindrical rotor and an annular stator which surrounds the outer cylindrical surface of the rotor.

The types of rotors previously used in axial gap motors include the reluctance type having recesses and projections formed of magnetic members at an end surface facing the stator, the permanent magnet type having north and south poles corresponding to rotational driving magnetic poles of the stator, and the induction type having radially arranged conductor rods (See Japanese Kokai 10-80113). Japanese Kokai 11-218130 discloses an axial gap motor which is a combination of the foregoing types in which permanent magnets are arranged at one axial end surface of a disc-shaped rotor and the axially opposite end face has recesses and projections of magnetic members. This latter motor produces torque between a stator having windings and the permanent magnets, as a permanent magnet synchronous machine, at the rotor surface which carries the permanent magnets, and produces torque by a magnetic field produced between the windings of the stator and the surface of the rotor having recesses and projections, as a reluctance motor. In this latter motor, the larger the difference in reluctance between the magnetic path (q-axis magnetic path) passing through the recesses and the magnetic path (d-axis magnetic path) passing through the projections, the larger the reluctance torque the motor produces.

### SUMMARY OF THE INVENTION

In a conventional reluctance type axial gap motor wherein the rotor presents a surface with recesses and projections, to increase the difference in reluctance between the magnetic path passing through the recesses and the magnetic path passing through the projections, it is necessary to increase the height of the projections (salient poles). However, there is the problem in that the aforementioned increase in the height of the projections results in an increase in the axial dimension of the motor itself.

Another problem is that if a motor is configured to act as a reluctance motor at one surface of its rotor and to act as a permanent magnet synchronous machine at the other surface of its rotor, similar to the motor disclosed in Japanese Kokai 10-80113 or Japanese Kokai 11-218130 mentioned above, the rotor resembles a combination of a rotor for a reluctance motor and a rotor for a permanent magnet synchronous machine, also contributing to an increase in the axial dimension.

### SUMMARY OF THE INVENTION

Thus, an object of the present invention is to provide an axial gap electric rotary machine which eliminates the difference in height between recesses and projections (salient poles) of the rotor required by the prior art, which is compact in its axial dimension, and which increases the difference in reluctance between the d-axis and q-axis magnetic paths. Another object of the present invention is to provide an axial gap electric rotary machine which functions as a reluctance type and as a permanent magnet synchronous machine at the same surface of the rotor and is compact in its axial dimension.

To attain the above objects, the present invention provides an axial gap electric rotary machine having a rotor and a stator which face each other with an axial gap therebetween, wherein the rotor has permanent magnets with their magnetic poles circumferentially arranged around the circumference of the rotor, preferable arranged at the outer peripheral surface of the rotor. The magnetic poles of adjacent permanent magnets are opposite in direction to each other. The rotor preferably has a disc shape in which the permanent magnets are arranged between rotor cores separated from each other with their magnetized surfaces facing the rotor cores, and in which the permanent magnets axially penetrate the rotor. In this case, the permanent magnets are each fan-shaped so that the distance between the magnetized surfaces increases radially outward of the rotor, or the permanent magnets are each rod-shaped with a rectangular cross section and have magnetized surfaces parallel to each other. In any of the above-described structures, the volume of the permanent magnet can be smaller than the volume of the space between the adjacent rotor cores.

The stator is preferably formed by arranging stator iron-core coils with the axes of their magnetic poles spaced around the circumference of the stator. More preferably, rotors are provided at both axial sides of the stator.

According to the axial gap electric rotary machine of the present invention, by arranging the magnetic poles of permanent magnets in the rotor around the circumference of the rotor, a desired reluctance can be obtained by the width of the permanent magnets, i.e., its dimension in the circumferential direction, independent of the axial thickness of the permanent magnets of the rotor, the function as a reluctance type electric rotary machine can be achieved while the axial dimension of the rotor is reduced. Moreover, the magnetic poles of the adjacent permanent magnets are arranged opposite each other, and hence north poles and south poles are alternately arranged around the circumference of the rotor facing a stator, which makes it possible to also achieve the function of a permanent magnet synchronous machine. Further, the permanent magnets axially penetrate the rotor, preferably completely through the axial dimension of the rotor, which eliminates the need for a rotor back yoke, whereby the axial dimension of the rotor is reduced, and consequently the electric rotary machine can be made more compact and an increase in efficiency by cutoff of leakage flux also becomes possible. When the permanent magnet is rod-shaped, the fabrication of the permanent magnet is facilitated. Furthermore, when the volume of the permanent magnet is made smaller than the volume of a space between adjacent rotor cores, setting of specifications for the electric rotary machine is facilitated.

In an embodiment wherein rotors are placed on both axially opposed sides of a stator, a large-output axial gap electric rotary machine is realized in an extremely compact structure. Likewise, in an embodiment wherein stators are placed on both axially opposed sides of a rotor, an extremely compact and large-output axial gap electric rotary machine is realized.

The rotor in the present invention is disc-shaped overall with the permanent magnets arranged between adjacent rotor cores, and thereby separated from each other, with their magnetized surfaces facing the rotor cores. The magnetic poles of the adjacent permanent magnets are opposite each other, and the permanent magnets penetrate through the axial dimension of the rotor, extending along axes parallel the axis of rotation (central axis) of the rotor. Moreover, the stator is formed by arranging stator iron-core coils with the axes of their magnetic poles spaced around the circumference of the stator.

The present invention is applicable to motors, generators, and motor-generators for all uses, and is particularly effective for uses in which the axial dimension of the electric rotary machine is strictly limited, for example, for a wheel motor contained in a wheel in an electric vehicle, and for a motor or a generator placed coaxially with or on an axis parallel to an engine in a hybrid vehicle.

### BRIEF DESCRIPTION OF THE DRAWINGS

FIG. 1 is a perspective schematic view of an axial gap electric rotary machine according to a first embodiment of the present invention;

FIG. 2 is a partially exploded perspective schematic view of a portion of the axial gap electric rotary machine of the first embodiment;

FIG. 3 is a circumferentially exploded sectional view of the stator and rotor of the first embodiment;

FIG. 4 is a view illustrating the relationship between permanent magnets and magnetic flux;

FIG. 5 is a partially exploded perspective schematic view of an axial gap electric rotary machine according to a second embodiment of the invention;

FIG. 6 is a circumferentially exploded sectional view of the stator and rotor of the second embodiment;

FIG. 7 is a schematic sectional view of the second embodiment;

FIG. 8 is a partially exploded perspective schematic view of an axial gap electric rotary machine according to a third embodiment of the invention;

FIG. 9 is a partially exploded perspective schematic view of a first modification of the third embodiment;

FIG. 10 is a partially exploded perspective schematic view of a second modification of the third embodiment;

FIG. 11 is a partially exploded perspective schematic view of a third modification of the third embodiment;

FIG. 12 is a partially exploded perspective schematic view of a fourth modification of the third embodiment;

FIG. 13 is a circumferentially exploded sectional view showing a conventional axial gap electric rotary machine; and

FIG. 14 is a circumferentially exploded sectional view of the rotor and stators of a fourth embodiment.

### DETAILED DESCRIPTION OF THE PREFERRED EMBODIMENT(S)

Embodiments of the present invention will be described below with reference to the drawings.

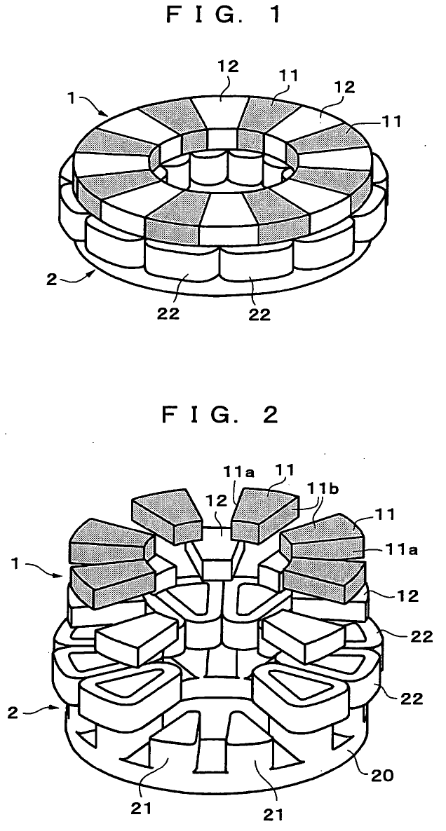

FIGS. 1 to 3 show a first embodiment of the present invention as including a rotor 1 having permanent magnets 11 with their magnetic poles arranged circumferentially around an annular disc rotor, that is to say, with their magnetized surfaces 11a and 11b extending radially of the rotor 1, and wherein the magnetic poles N and S of adjacent magnets 11 alternate around the circumference of the rotor. Rotor cores 12 made of a magnetic substance are arranged between the magnets, and thus are separated from each other. Namely, the rotor cores 12 and the permanent magnets 11 are alternately arranged. In this embodiment, each of the permanent magnets 11 and the rotor cores 12 is fan-shaped, with its inner arc surface and outer arc surface having the same curvature, and with radially extending surfaces on both sides connecting the inner and outer arc surfaces. The permanent magnets 11 and the rotor cores 12 have the same axial thickness. These shapes allow the permanent magnets 11 and the rotor cores 12 to form an annular disc-shaped rotor having a small axial thickness.

FIG. 2 shows a stator 2 facing the rotor 1 across a gap. The stator 2 is made of a magnetic substance and has an annular disc shape with the same inner and outer radii as the annular disc-shaped rotor 1, and wedge-shaped projections 21 which project from its one axial end surface (the end surface on the gap side facing the rotor 1) and which have corner portions which are rounded and are arranged at regular circumferential intervals. A winding 22 is placed around each of the projections 21. The respective projections 21 constitute the core of the stator, and the disc-shaped annular portion 20 constitutes a stator back yoke. Note that elements on the front side which prevent elements on the back side from being seen are omitted in FIG. 2 which shows a portion of the elements in exploded view, as in the partial exploded views of all of the later-described embodiments.

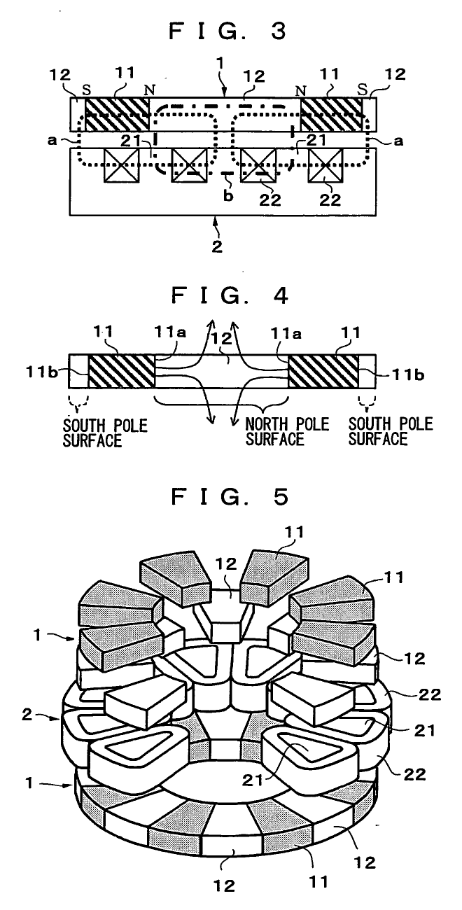

In FIG. 3, elements denoted by the same numerals and symbols which are used to designate elements corresponding to those shown in FIG. 1 and FIG. 2 described above, are not again described. In the structure of this first embodiment, as shown in FIG. 3, magnetic paths between the rotor 1 and the stator 2 are separated. A magnetic path “a” (shown by a dotted line in FIG. 3) passes through the permanent magnets 11 and a magnetic path “b” (shown by a dashed line in FIG. 3) passes through only the magnetic cores 12, that is, the magnetic path “b” does not pass through the permanent magnets 11. Since the permanent magnets 11 have a large reluctance, the difference in reluctance between the magnetic path “a” and the magnetic path “b” is related to the thickness of the permanent magnet 11 (distance between magnetic pole surfaces). As a result, in a conventional axial gap motor which produces reluctance torque, the difference in reluctance between the d-axis and the q-axis magnetic paths is dependent on the height of salient poles at an axial end surface of the rotor, whereas in this embodiment, the difference in reluctance between the d-axis and q-axis magnetic paths is produced by separation of the magnetic path “a” which passes through the permanent magnets 11 and the magnetic path “b” which does not pass therethrough. Accordingly, in this embodiment, the formation of recesses and projection are unnecessary to produce the difference in reluctance, and salient poles become unnecessary, so that higher reluctance torque can be produced by a rotor with a smaller thickness.

Further, in this first embodiment, as shown in FIG. 4, by arranging the permanent magnets 11 with their magnetic poles arranged circumferentially (the right-and-left direction in FIG. 4) around the rotor, in other words, with their magnetized surfaces extending radially (vertical direction orthogonal to the paper surface in FIG. 4) with respect to the rotor, north poles and south poles alternate with core portions at the axial end surface of the rotor 1. Specifically, the magnetic path “a” shown in FIG. 3 created by the magnetic force of the permanent magnet 11 interacts with magnetic force and produced by the windings 22 of the stator 2 to produce torque, as in a conventional permanent magnet synchronous machine. Consequently, at the interface between the rotor 1 and the stator 2, reluctance torque and the torque of a permanent magnet synchronous machine can be produced at the same time, whereby an axial gap motor capable of outputting higher torque is realized. In contrast, in the prior art, either the reluctance torque or the torque as the permanent magnet synchronous machine is produced at one axial surface of the rotor. As compared with the prior art, in this embodiment, at one surface, torque almost equal to that produced by the conventional motors at both surfaces can be obtained.

For comparison, the magnetic paths of the prior art, wherein the magnetized surfaces 11a and 11b of the permanent magnets 11 are arranged axially of the rotor are shown in FIG. 13 using the same notation as in FIG. 3. When the magnetized surfaces of the permanent magnet 11 are arranged axially of the rotor as shown in FIG. 13, the rotor requires a back yoke 10 in order to close the magnetic path between the adjacent magnets, whereby the thickness of the rotor 1 is increased. Moreover, in the first embodiment shown in FIG. 3, the magnetic poles of the permanent magnets are arranged circumferentially around the rotor and hence the thickness of the rotor in the circumferential direction is a main factor determining the difference in reluctance. On the other hand, in the prior art shown in FIG. 13, the magnetized surfaces 11a and 11b of the permanent magnet 11 extend axially of the rotor, and hence to obtain d-axis reluctance equal to that of the embodiment shown in FIG. 3, the thickness of the rotor is increased by the length of the magnet in the direction of magnetization.

Further, in the conventional structure, among the magnetic flux lines in the d-axis magnetic path (magnetic path “d” shown in FIG. 13), is a magnetic flux line which bypasses the permanent magnet 11, that is, a so-called leakage flux. This leakage flux becomes a primary factor in loss of reluctance torque. But in the conventional structure, the leakage flux cannot be completely eliminated since the core is around the magnet. In contrast, in the embodiment shown in FIG. 3, the permanent magnet 11 axially penetrates (extends completely through) the rotor 1, so that a core portion connecting the magnetic poles of the magnet can be completely eliminated, whereby the leakage flux can be almost completely eliminated. Accordingly, the magnetic flux lines along the d-axis magnetic path (See the magnetic path “a” shown in FIG. 3) are certain to pass through the magnet 11, which makes it possible to more effectively produce reluctance torque.

Incidentally, in the field of motor technology, for reluctance motors and permanent magnet motors, the d-axis and the q-axis designations are sometimes reversed and hence, definitions of the d-axis and the q-axis are arbitrary for a motor which uses reluctance torque and permanent magnet torque together. The present invention is characterized in that the difference in reluctance between the d-axis and q-axis magnetic paths is increased, irrespective of the definitions of the d-axis and the q-axis.

In the second embodiment shown in FIGS. 5 to 7, a double rotor type arrangement structure, in which rotors 1 are both the same as rotor 1 in the first embodiment, are provided at both axial sides of the stator 2 having windings 22. In this embodiment, the structure of the stator 2 itself is different from that of the first embodiment. As shown in FIG. 5, the stator 2 in this embodiment has iron-core coils are formed of windings 22 around the cores 21 and are circumferentially joined. To be more precise, each of the stator cores 21 has a winding 22 around its circumferential surface and has the same shape as the projection in the first embodiment and, by joining them circumferentially, the whole annular disc-shaped stator 2 is formed without a stator back yoke.

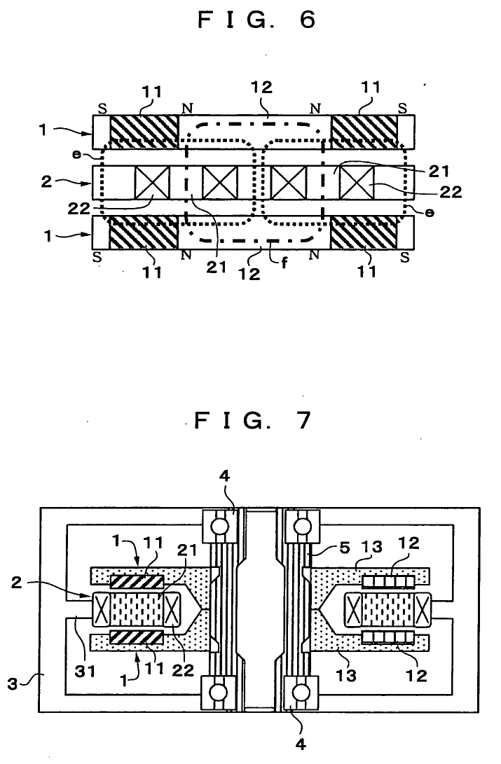

FIG. 6 shows the d-axis and q-axis magnetic paths which produce reluctance torque in this second embodiment. In this case, as shown in FIG. 6, a magnetic path “e” is a magnetic path passing through the permanent magnets 11 of the upper and lower rotors 1, whereby the difference in reluctance between the magnetic path “e” and a magnetic path “f”, which does not pass through any magnet, becomes larger than that in the first embodiment and the reluctance torque is increased. Moreover, since both reluctance torque and the torque as a permanent magnet synchronous machine can be produced at both axial surfaces of the stator 2, a much higher torque can be produced as compared with the conventional axial gap motor of equal size. Further, as can be seen from a comparison with FIG. 13 shown above, by placing the rotors 1 on both sides of the stator 2, the back yoke for the stator 2 becomes unnecessary. This is because a closed magnetic path can be formed by the stator 2 and cores of the rotors 1 on both sides thereof without a stator back yoke. Accordingly, in this second embodiment, it is possible to increase output torque per unit volume of a motor by an amount corresponding to the elimination of the back yoke. Furthermore, since there is no back yoke in the stator, the magnetic path can be correspondingly shortened, which makes it possible to reduce reluctance of the entire magnetic path, whereby magnetic flux can be more efficiently used, and consequently the efficiency of the motor is also improved.

FIG. 7 shows that the rotors 1 and the stator 2 are housed in a casing 3, that the stator 2 has its outer circumference supported by a support 31 which extends radially inward from a peripheral wall of the casing 3, that a rotating shaft 5 is supported at opposing end walls of the casing 3 via bearings 4, and that a pair of rotors 1 are fixed on the rotating shaft 5 and sandwich the stator 2 therebetween. The rotors 1 in this case are coupled to the rotating shaft 5 via rotor hubs 13, respectively, as shown by a section through the permanent magnets and a section through the cores on opposing sides of the rotor shaft 5 in FIG. 7. In FIG. 7, a section shown by vertical broken lines represents a section of the stator core 21, and similarly a section designated “X” represents a section of the stator winding 22, a section shown by vertical lines at short intervals represents a section of the rotating shaft 5, a section shown by dots represents a section of the rotor hub 13, a section shown by vertical lines at long intervals represents a section of the rotor core 12, and a section shown by oblique lines represents a section of the rotor permanent magnet 11. Incidentally, the rotor hub 13 serves to fix the permanent magnets 11 and the rotor cores 12 of the rotor 1, constituting the rotor, to the rotatable shaft 5, and is made of a non-magnetic material, whereby it has no influence on any magnetic field. Hence, even with the rotor hub 13, the effect produced by this embodiment is the same as explained with reference to FIG. 6.

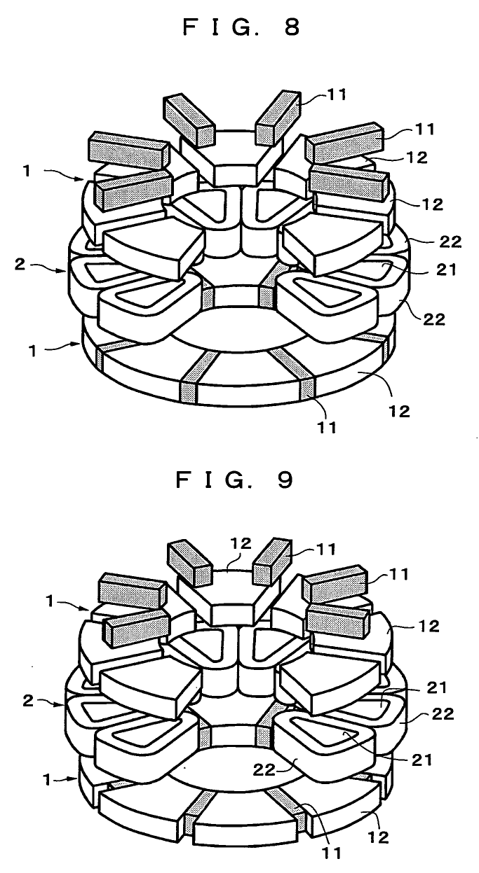

A third embodiment, shown in FIGS. 8 to 12, has a rotor with a structure different from that of the second embodiment. In this third embodiment, the same double rotor type as in the second embodiment is adopted by way of example, but this third embodiment is also applicable to the single rotor design of the first embodiment. In this third embodiment, the permanent magnets 11 are rod-shaped with a rectangular cross section, and thus easily fabricated. Accordingly, the radially extending surfaces of the rotor cores 12 do not exactly lead to the center of the rotor 1, and the facing radially extending surfaces of adjacent rotor cores 12 are parallel to each other. The other features of this embodiment are all the same as those of the second embodiment shown in FIG. 5, so that the same numerals and symbols are used to designate corresponding members and description thereof is omitted.

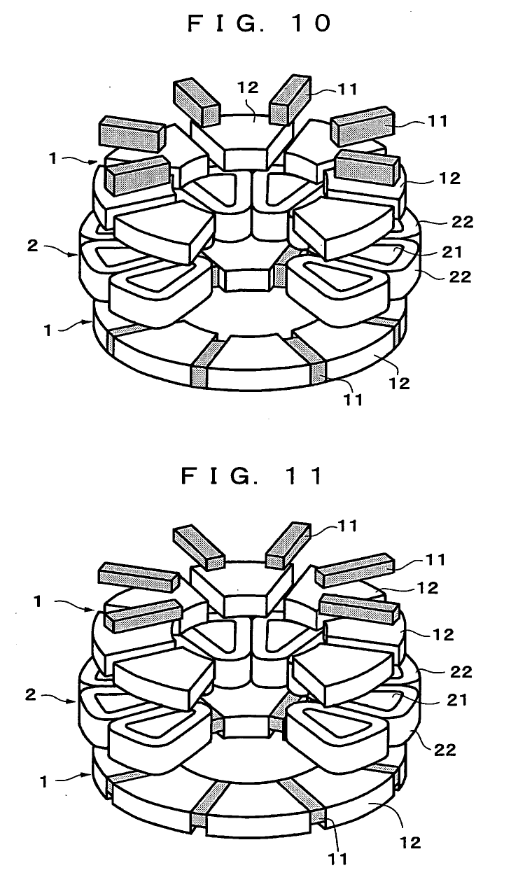

In the example shown in FIG. 8, the volume of a permanent magnet 11 corresponds to the volume of a space between the adjacent rotor cores 12, and in the examples shown in FIG. 9 to FIG. 12, the volume of a permanent magnet 11 is smaller than the volume of the space between the adjacent rotor cores 12. In the examples in FIG. 9 and FIG. 10, the length of the permanent magnet 11 in the radial direction is shorter than the difference between the inner and outer radiuses of the rotor core 12. In the example in FIG. 9, the inner end side of the permanent magnet 11 is aligned with the position of the inner circumferential surface of the rotor core 12, and more specifically, the positions of both vertical edges of an inner end surface of a permanent magnet are located in positions matching (circumferentially aligned with) the positions of adjacent vertical edges of inner circumferential edges of adjacent rotor cores 12. In the example of FIG. 10, the outer end side of the permanent magnet 11 is aligned with the position of the outer circumferential surface of the rotor core 12 and, more specifically, the positions of both vertical edges of an outer end surface of the permanent magnet are located in positions matching the positions of outer vertical edges of adjacent rotor cores 12.

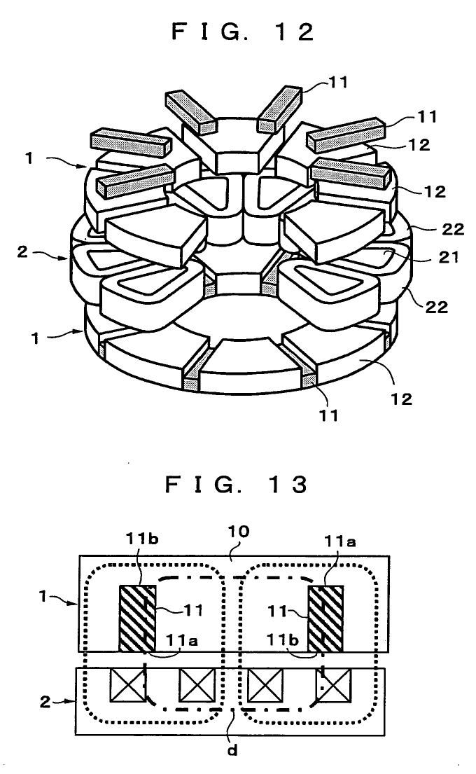

In the embodiments shown in FIG. 11 and FIG. 12, the axial thickness of the permanent magnets 11 is thinner than the axial thickness of the rotor cores 12. FIG. 11 shows an embodiment in which at the surface of the rotor which faces the stator 2, the surfaces of the permanent magnets 11 and the rotor cores 12 are coplanar, i.e., on the same level. FIG. 12 shows an embodiment in which at the surface of the rotor opposite the surface which faces the stator 2, the surfaces of the permanent magnets 11 and the rotor cores 12 are coplanar, i.e., on the same level.

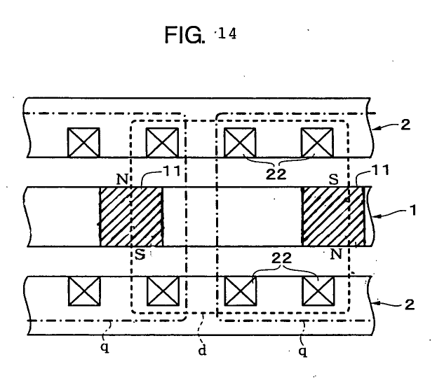

In the embodiments shown in FIGS. 9 to 12, the size, shape or placement of the permanent magnets 11 is variously changed without changing the positional relationship between the adjacent rotor cores 12. In the present invention, the reluctance torque is independent of the permanent magnets 11 and dependent on the arrangement of the rotor cores 12, so that in all of the embodiments shown in FIG. 9 to FIG. 12, the same amount of reluctance torque is produced. In contrast, rotational torque produced by the permanent magnets 11 is dependent on the size, shape and placement of the permanent magnets 11, whereby it is possible to change the permanent magnet torque by the placement of the permanent magnets 11. In particular, the larger the permanent magnet 11, the higher the electromotive back voltage in high-speed rotation, and consequently high-speed rotation becomes difficult. Accordingly, by utilizing permanent magnets 11 having a volume smaller than the volume of the space between adjacent rotor cores, the electromotive back voltage can be reduced to provide a motor suitable for high-speed rotation. To obtain the same effect, it is also possible to divide a permanent magnet between adjacent cores into plural parts in any of the above-described embodiments. Such division of the individual permanent magnets offers the advantage of reduction in the eddy current generated in the permanent magnet, thus providing a more efficient motor. Moreover, in all of the above-described embodiments, it is not essential for the present invention that the permanent magnets be in contact with the adjacent rotor cores or, in other words, a clearance may be provided between the rotor cores and the permanent magnets. In the second embodiment, the rotors are placed on both axially opposite sides of the stator and an embodiment in which stators are placed on both axially opposite sides of a rotor is also possible. This latter structure may be realized by, for example in the first embodiment shown in FIG. 1, placing another stator, which is the same as the stator 2, on the side of the rotor 1 opposite the illustrated stator 2, as shown in FIG. 14, thereby increasing the torque produced in the first embodiment. Further, the present invention can produce the same effect regardless of the method of stator winding such as distributed winding or concentrated winding.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An axial gap electric rotary machine having at least a first rotor and a first stator, said first rotor and said first stator facing each other with an axial gap therebetween, wherein
said first rotor comprises permanent magnets arranged with their magnetic poles spaced apart around the circumference of said rotor.

2. The axial gap electric rotary machine according to claim 1, wherein the magnetic poles of the adjacent permanent magnets are opposite each other.

3. The axial gap electric rotary machine according to claim 2, wherein said rotor has a disc shape in which the permanent magnets are arranged between adjacent rotor cores, each of said permanent magnets having magnetized surfaces facing respective adjacent rotor cores and extending completely through an axial dimension of said rotor.

4. The axial gap electric rotary machine according to claim 3, wherein the permanent magnets are each fan-shaped so that, for each permanent magnet, a distance between the magnetized surfaces increases radially outward of said rotor.

5. The axial gap electric rotary machine according to claim 3, wherein the permanent magnets are rod-shaped with a rectangular cross-section and in each permanent magnet the magnetized surfaces parallel each other.

6. The axial gap electric rotary machine according to claim 1, wherein said rotor has a disc shape in which the permanent magnets are arranged between adjacent rotor cores, each of said permanent magnets having magnetized surfaces facing respective adjacent rotor cores and extending completely through an axial dimension of said rotor.

7. The axial gap electric rotary machine according to claim 6, wherein the permanent magnets are each fan-shaped so that, for each permanent magnet a distance between the magnetized surfaces increases radially outward of said rotor.

8. The axial gap electric rotary machine according to claim 6, wherein the permanent magnets are rod-shaped with a rectangular cross-section and in each permanent magnet the magnetized surfaces parallel each other.

9. The axial gap electric rotary machine according to claim 1, wherein volume of each of said permanent magnets is smaller than volume of a space between adjacent rotor cores.

10. The axial gap electric rotary machine according to claim 1, wherein said first stator is formed by arranging stator iron-core coils with axes of their magnetic poles spaced around the circumference of said first stator.

11. The axial gap electric rotary machine according to claim 1, further comprising a second rotor on the side of said first stator axially opposite said first rotor.

12. The axial gap electric rotary machine according to claim 1, further comprising a second stator on the side fo said first rotor axially opposite said first stator.

13. The axial gap electric rotary machine according to claim 1 wherein adjacent permanent magnets are separated by rotor cores and thus alternate with rotor cores around the circumference of the rotor.
